(19) United States
(12) Patent Application Publication
(10) Pub. No.: US 2018/0358032 A1
(43) Pub. Date: Dec. 13, 2018

(54) SYSTEM FOR COLLECTING AND PROCESSING AUDIO SIGNALS

(71) Applicants: RYO TANAKA, CONCORD, MA (US); PASCAL CLEVE, SUDBURY, MA (US); BHARATH RENGARAJAN, WALTHAM, MA (US)

(72) Inventors: RYO TANAKA, CONCORD, MA (US); PASCAL CLEVE, SUDBURY, MA (US); BHARATH RENGARAJAN, WALTHAM, MA (US)

(21) Appl. No.: 15/906,123

(22) Filed: Feb. 27, 2018

Related U.S. Application Data
(60) Provisional application No. 62/518,315, filed on Jun. 12, 2017.

(51) Int. Cl. G10L 21/0272; G10L 21/0208

(52) U.S. Cl. CPC G10L 21/0272; H04R 3/005; G10L 2021/02082; G10L 21/0208

(57) ABSTRACT

A sound collecting system is provided with a microphone array having a plurality of microphones, a first echo canceller that receives a sound signal from the microphone and removes at least some of an acoustic echo component from the sound signal, a beam forming unit that that forms directivity by processing the partially echo removed sound signal collected from the microphone array, and a second echo canceller disposed after on the back of the beam forming unit that operates to remove the residual acoustic echo in the sound signal.

### 1. FIELD OF THE INVENTION

The present disclosure relates to audio and video conferencing systems and methods for controlled a microphone array beam direction.

### 2. BACKGROUND

Generally, when collecting a human voice far from a microphone, noise or a reverberation component that is undesirable to collect is relatively large compared to the human voice. Therefore, the sound quality of the voice to be collected is remarkably reduced. Because of this, it is desired to suppress the noise and the reverberation component, and clearly collect only the voice.

In conventional sound collecting devices, sound collecting of a human voice is carried out by detecting the direction of arrival of a noise acquired by a microphone, and adjusting the beam forming focus direction. However, in conventional sound collecting devices, the beam forming focus direction is adjusted not only for a human voice, but also for noise. Because of this, there is a risk that unnecessary noise is collected and that the human voice can only be collected in fragments.

### 3. SUMMARY

An object of a number of embodiments according to the present invention is to provide a sound collecting device that collects only the sound of a human voice by analyzing an input signal, a sound emitting/collecting device, a signal processing method, and a medium.

The sound collecting device is provided with a plurality of microphones, a beam forming unit that forms directivity by processing a collected sound signal of the plurality of microphones, a first echo canceller disposed on the front of the beam forming unit, and a second echo canceller disposed on the back of the beam forming unit.

### 4. BRIEF DESCRIPTION OF THE DRAWINGS

FIG. 1 is a perspective view schematically illustrating a sound emitting/collecting device 10.

FIG. 2 is a block diagram of the sound emitting/collecting device 10.

FIG. 3A is a functional block diagram of the sound emitting/collecting device 10.

FIG. 3B is a diagram showing functionality comprising a second AEC 40.

FIG. 4 is a block diagram illustrating a configuration of a voice activity detection unit 50.

FIG. 5 is a diagram illustrating a relationship between the direction of arrival and the displacement of sound due to the microphone.

FIG. 6 is a block diagram illustrating a configuration of a direction of arrival unit 60.

FIG. 7 is a block diagram illustrating a configuration of a beam forming unit 20.

FIG. 8 is a flowchart illustrating an operation of the sound emitting/collecting device.

### 5. DETAILED DESCRIPTION

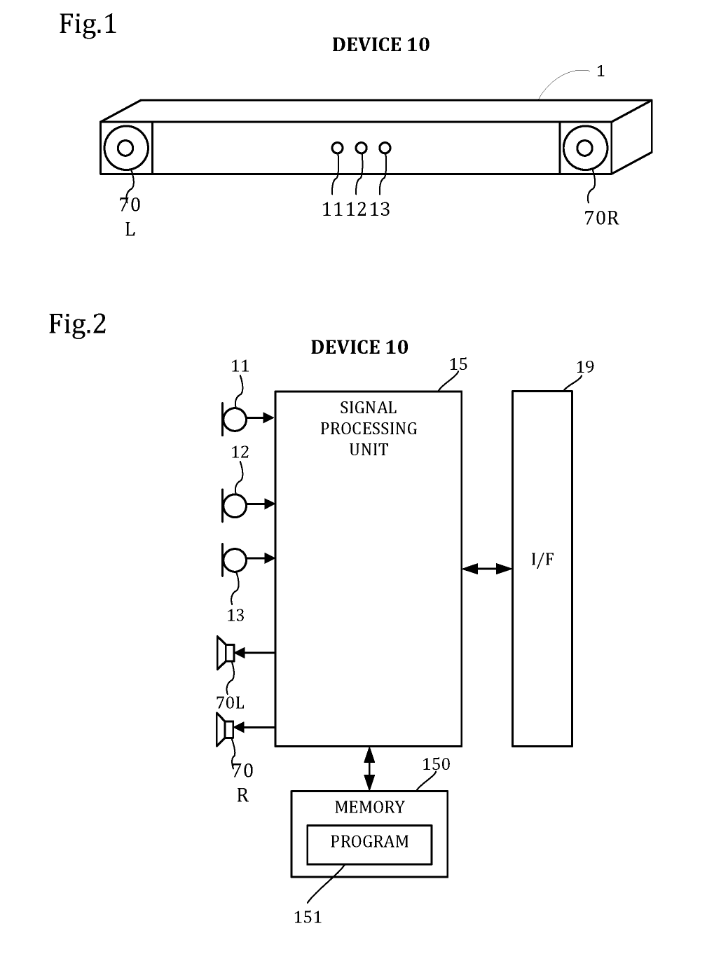

FIG. 1 is a perspective view schematically illustrating the sound emitting/collecting device 10, such as an audio or videoconferencing device. The sound emitting/collecting device 10 is provided with a rectangular parallelepiped housing 1, a microphone array having microphones 11, 12, and 13, a speaker 70L, and a speaker 70R. The plurality of microphones comprising the array are disposed in a line on one side surface of the housing 1. The speaker 70L and the speaker 70R are disposed as a pair on the outer sides of the microphone array interposing the microphone array therebetween. In this example, the array has three microphones, but the sound emitting/collecting device 10 can operate as long as at least two or more microphones are installed. Furthermore, the number of speakers is not limited to two, and the sound emitting/collecting device 10 can operate as long as at least one or more speakers are installed. Furthermore, the speaker 70L or the speaker 70R may be provided as a separate configuration from the housing 1.

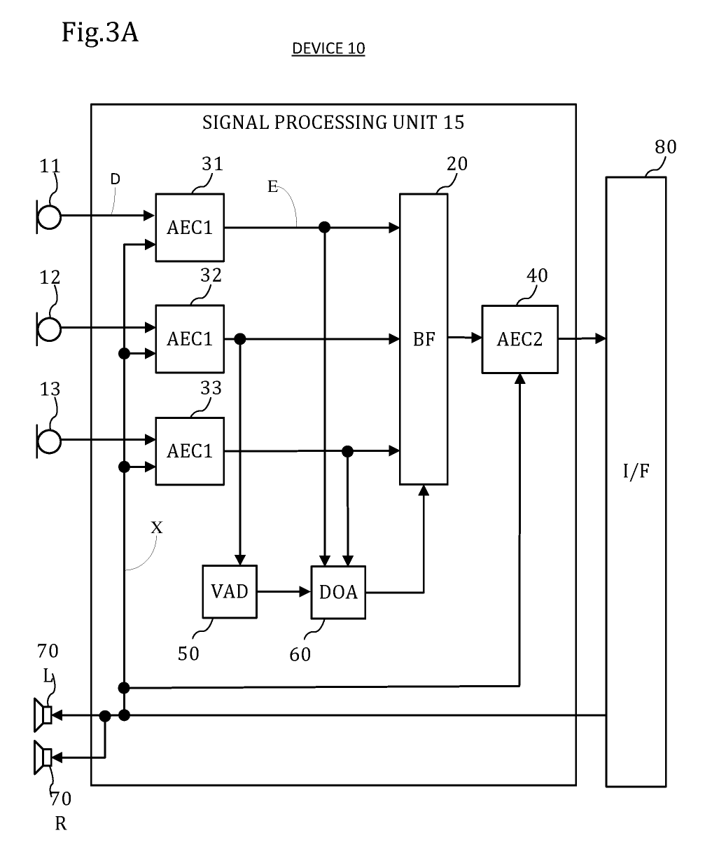

FIG. 2 is a block diagram of the sound emitting/collecting device 10 illustrating a microphone array (11, 12, 13), the speakers 70L and 70R, the signal processing unit 15, a memory 150, and an interface (I/F) 19. A collected sound/audio signal, which is a voice signal acquired by the microphones, is operated on by the signal processing unit 15, and is input to the I/F 19. The I/F 19 is, for example, a communications I/F, and transmits the collected sound signal to an external device (remote location). Alternatively, the I/F 19 receives an emitted sound signal from an external device. The memory 150 saves the collected sound signal acquired by the microphone as recorded sound data.

The signal processing unit 15 operates on the sound acquired by the microphone array as described in detail below. Furthermore, the signal processing unit 15 processes the emitted sound signal input from the OF 19. The speaker 70L or the speaker 70R emit the signal that has undergone signal processing in the signal processing unit 15. Note that the functions of the signal processing unit 15 can also be realized in a general information processing device, such as a personal computer. In this case, the information processing device realizes the functions of the signal processing unit 15 by reading and executing a program 151 stored in the memory 150, or a program stored on a recording medium such as a flash memory.

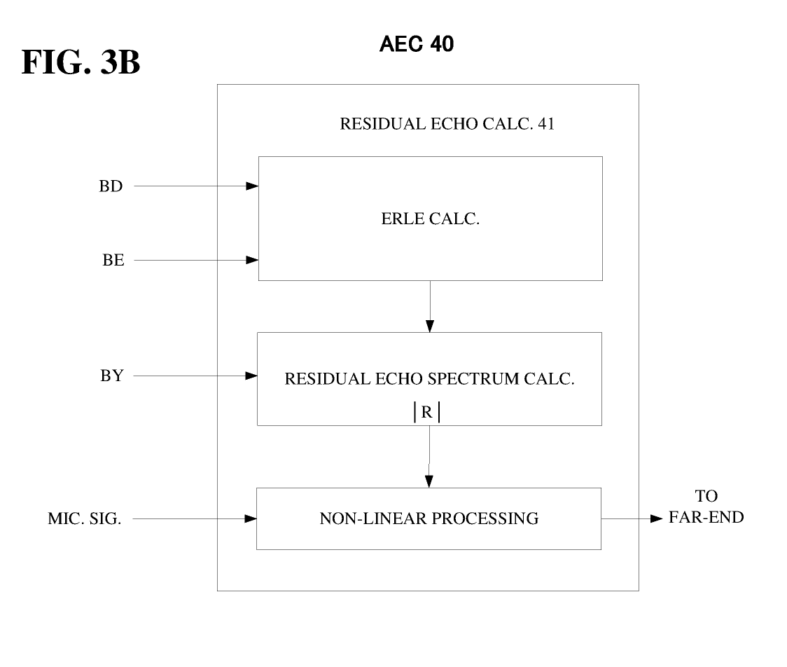

FIG. 3A is a functional block diagram of the sound emitting/collecting device 10, which is provided with the microphone array, the speakers 70L and 70R, the signal processing unit 15, and the interface (I/F) 19. The signal processing unit 15 is provided with first echo cancellers 31, 32, and 33, a beam forming unit (BF) 20, a second echo canceller 40, a voice activity detection unit (VAD) 50, and a direction of arrival unit (DOA) 60.

The first echo canceller 31 is installed on the back of the microphone 11, the first echo canceller 32 is installed on the back of the microphone 12, and the first echo canceller 33 is installed on the back of the microphone 13. The first echo cancellers carry out linear echo cancellation on the collected sound signal of each microphone. These first echo cancellers remove echo caused by the speaker 70L or the speaker 70R to each microphone. The echo canceling carried out by the first echo cancellers is made up of an FIR filter process and a subtraction process. The echo canceling of the first echo cancellers is a process that inputs a signal (X) emitted from the speaker 70L or the speaker 70R (emitted sound signal) that has been input to the signal processing unit 15 from the interface (I/F) 19, estimates an echo component (Y) using the FIR filter, and subtracts each estimated echo component from the sound signal (D) collected from each microphone and input to the first echo cancellers which results in an echo removed sound signal (E).

Continuing to refer to FIG. 3A, the VAD 50 receives sound information received from, in this case, one of the echo cancellers 32, and it operates to determine whether the sound signal collected in the microphone 12 is associate with voice information. When it is determined in the VAD 50 that there is a human voice, a voice flag generated and sent to the DOA 60. The VAD 50 will be described in detail below. Note that the VAD 50 is not limited to being installed on the back of the first echo canceller 32, and it may be installed on the back of the first echo canceller 32 or the first echo canceller 33.

The DOA 60 receives sound information from, in this case, two of the echo cancellers, AEC 31 and 33, and operates to detect the direction of arrival of voice. The DOA 60 detects a direction of arrival (θ) of the collected sound signal collected in the microphone 11 and the microphone 13 after the voice flag is input. The direction of arrival (θ) will be described later in detail. However, when the voice flag has been input in the DOA 60, the value of the direction of arrival (θ) does not change even if noise other than that of a human voice occurs. The direction of arrival (θ) detected in the DOA 60 is input to the BF 20. The DOA 60 will be described in detail below.

The BF 20 carries out a beam forming process based on the input direction of arrival (θ) of sound. This beam forming process allows sound in the direction of arrival (θ) to be focused on. Therefore, because noise arriving from a direction other than the direction of arrival (θ) can be minimized, it is possible to selectively collect voice in the direction of arrival (θ). The BF 20 will be described in more detail later.

A second echo canceller 40, illustrated in FIG. 3A, performs non-linear echo cancellation, and operates on the beamformed microphone signal to remove the remaining echo component that could not be removed by the subtraction process (AEC1) alone by employing a frequency spectrum amplitude multiplication process

Functional elements comprising the second echo canceller 40 are shown and described in more detail with reference to FIG. 3B. The AEC 40 comprises a residual echo calculation function 41 having an Echo Return Loss Enhancement (ERLE) calculation function, a Residual Acoustic Echo Spectrum calculation function |R|, and a Non-Linear Processing function. The frequency spectrum amplitude multiplication process may be any kind of process, but uses, for example, at least one or all of a spectral gain, a spectral subtraction, and an echo suppressor in a frequency domain. The remaining echo component is comprised of background noise in a room {i.e., an error component caused by an estimation error of the echo component occurring in the first echo canceller 31), oscillation noise of the housing occurring when the sound emitting level of the speaker 70L or the speaker 70R reaches a certain level. The second echo canceller 40 estimates the spectrum of the remaining or residual acoustic echo component |R|, based on the spectrum of the echo component estimated in the subtraction process in the first echo cancellers, and based on the spectrum of how much echo is removed (ERLE) by the first echo cancellers as follows in Equation 1.

|R|=|BY|/(ERLÊ0.5), with ERLE=power(BD/power(BE), Equation 1:

and with BD being a microphone signal after BF, BE being the output of AEC1 after BF and BY being acoustic echo estimate after BF.

The estimated spectrum of the remaining acoustic echo component |R| is removed from the input signal (BF microphone signal) by damping the spectrum amplitude by multiplication, and the degree of input signal damping is determined by the value of |R|. The larger the value of the calculated residual echo spectrum, the more damping is applied to the input signal (this relationship can be determined empirically). In this manner, the signal processing unit 15 of the present embodiment also removes a remaining echo component that could not be removed by the subtraction process.

The frequency spectrum amplitude multiplication process is not carried out prior to beam forming, as the phase information of the collected sound signal level gain is lost, therefore making a beam forming process difficult by the BF 20. Furthermore, the frequency spectrum amplitude multiplication process is not carried out prior to beam forming in order to preserve the information of the harmonic power spectrum, power spectrum change rate, power spectrum flatness, formant intensity, harmonic intensity, power, first-order difference of power, second-order difference of power, cepstrum coefficient, first-order difference of cepstrum coefficient, or second-order difference of cepstrum coefficient described below, and as such, voice activity detection is possible by the VAD 50. Then, the signal processing unit 15 of the present embodiment removes the echo component using the subtraction process, carries out the beam forming process by the BF 20, the voice determination by the VAD 50, and the detection process of the direction of arrival in the DOA 60, and carries out the frequency spectrum amplitude multiplication process on the signal that has undergone beam forming.

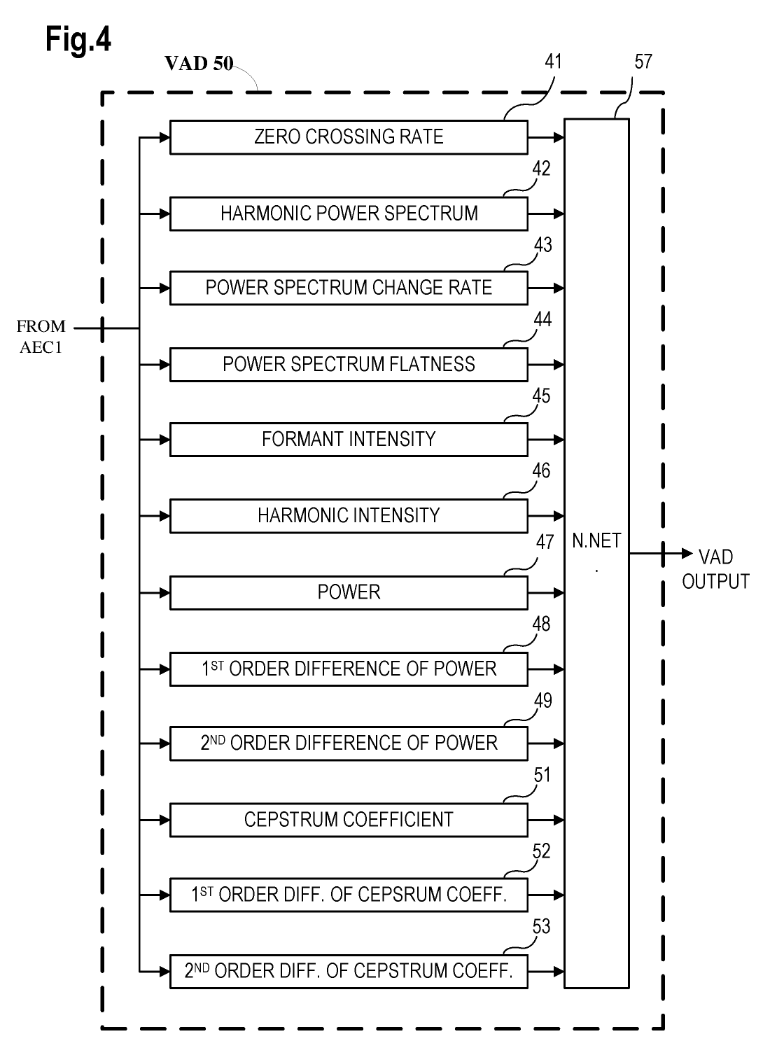

Next, the functions of the VAD 50 will be described in detail using FIG. 4. The VAD 50 carries out an analysis of various voice features in the voice signal using a neural network 57. The VAD 50 outputs a voice flag when it is determined that there is a human voice as a result of analysis. The following are given as examples of various voice features: zero-crossing rate 41, harmonic power spectrum 42, power spectrum change rate 43, power spectrum flatness 44, formant intensity 45, harmonic intensity 46, power 47, first-order difference of power 48, second-order difference of power 49, cepstrum coefficient 51, first-order difference of cepstrum coefficient 52, and second-order difference of cepstrum coefficient 53.

The zero-crossing rate 41 calculates the number of times an audio signal changes from a positive value to negative or vice-versa in a given audio frame. The harmonic power spectrum 42 indicates what degree of power each harmonic component of the audio signal has. The power spectrum change rate 43 indicates the rate of change of power to the frequency component of the audio signal. The power spectrum flatness 44 indicates the degree of the swell of the frequency component of the audio signal. The formant intensity 45 indicates the intensity of the formant component included in the audio signal. The harmonic intensity 46 indicates the intensity of the frequency component of each harmonic included in the audio signal. The power 47 is the power of the audio signal. The first-order difference of power 48, is the difference from the previous power 47. The second-order difference of power 49, is the difference from the previous first-order difference of power 48. The cepstrum coefficient 51 is the logarithm of the discrete cosine transformed amplitude of the audio signal. A first-order difference 52 of the Cepstrum coefficient is the difference from the previous Cepstrum coefficient 51. A second-order difference 53 of the cepstrum coefficient is the difference from the previous first-order difference 52 of the cepstrum coefficient.

It should be noted that when finding the Cepstrum coefficient 51, the high frequency component of the audio signal can be emphasized by using a pre-emphasis filter. This audio signal may then be further processed by a Mel filter bank and a Discrete Cosine Transform to give the final coefficients needed. Finally, it should be understood that the voice features are not limited to the parameters described above, and any parameter that can discriminate a human voice from other sounds may be used.

I should be understood, that a voice signal emphasizing a high frequency may be used when finding the cepstrum coefficient 51 by using a pre-emphasis filter, and a discrete cosine transformed amplitude of the voice signal compressed by a mel filter bank may be used. Further, it should be understood that the voice features are not limited to the parameters described above, and any parameter that can discriminate a human voice from other sounds may be used.

The neural network 57 is a method for deriving results from a judgment example of a person, and each neuron coefficient is set to an input value so as to approach the judgment result derived by a person. More specifically, the neural network 57 is a mathematical model made up of a known number of nodes and layers used to determine whether a current audio frame is human voice or not. The value at each of these nodes is computed by multiplying the values of the nodes in the previous layers with weights and adding some bias. These weights and bias are obtained beforehand for every layer of the neural network by training it with a set of known examples of speech and noise files.

The neural network 57 outputs a predetermined value based on an input value by inputting the value of various voice features (zero-crossing rate 41, harmonic power spectrum 42, power spectrum change rate 43, power spectrum flatness 44, formant intensity 45, harmonic intensity 46, power 47, first-order difference of power 48, second-order difference of power 49, cepstrum coefficient 51, first-order difference of cepstrum coefficient 52, or second-order difference of cepstrum coefficient 53) in each neuron. The neural network 57 outputs each of a first parameter value, which is a human voice, and a second parameter value, which is not a human voice in the final two neurons. Finally, the neural network 57 determines that it is a human voice when the difference between the first parameter value and the second parameter value exceeds a predetermined threshold value. By this, the neural network 57 can determine whether the voice signal is a human voice based on the judgment example of a person.

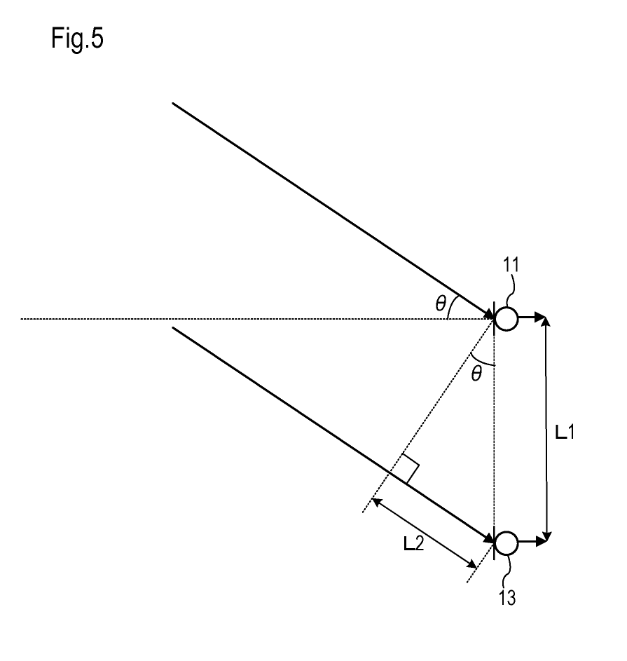

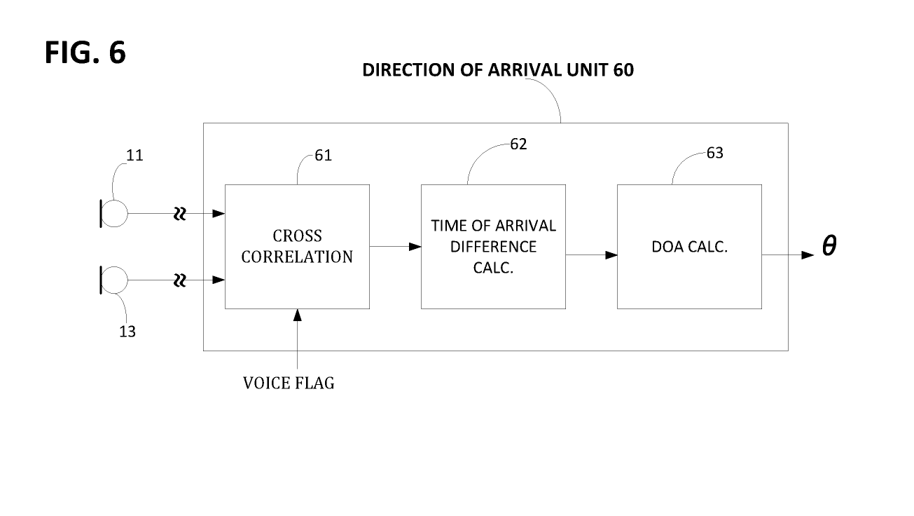

Next, the functions of the DOA 60 will be described in detail using FIG. 5 and FIG. 6. FIG. 5 is a diagram illustrating the relationship between the direction of arrival and the displacement of sound due to the microphone. FIG. 6 is a block diagram illustrating the configuration of the DOA 60. In FIG. 5, the arrow in one direction indicates the direction from which the voice from the sound source arrives. The DOA 60 uses the microphone 11 and the microphone 13 that are separated from each other by a predetermined distance (L1). Referring to FIG. 6, when the voice flag is input to the DOA 60, the cross-correlation function of the collected sound signal collected in the microphone 11 and the microphone 13 is detected in block 61. Here, the direction of arrival (θ) of the voice can be expressed as the displacement from a direction perpendicular to the surface on which the microphone 11 and the microphone 13 are positioned. Because of this, a sound displacement (L2) associated with the direction of arrival (θ) occurs in the input signal to the microphone 13 relative to the microphone 11.

The DOA 60 detects the time difference of the input signals of each of the microphone 11 and the microphone 13 based on the peak position of the cross-correlation function. The sound displacement (L2) is calculated by the product of the time difference of the input signal and the sound speed. Here, L2=L1*sinθ. Because L1 is a fixed value, it is possible to detect 63 (referring to FIG. 6) the direction of arrival (θ) from L2 by a trigonometric function operation. Note that when the VAD 50 determines that there is no human voice as a result of analysis, the DOA 60 does not detect the direction of arrival (θ) of the voice, and the direction of arrival (θ) is maintained at the preceding (i.e., last calculated) direction of arrival (θ).

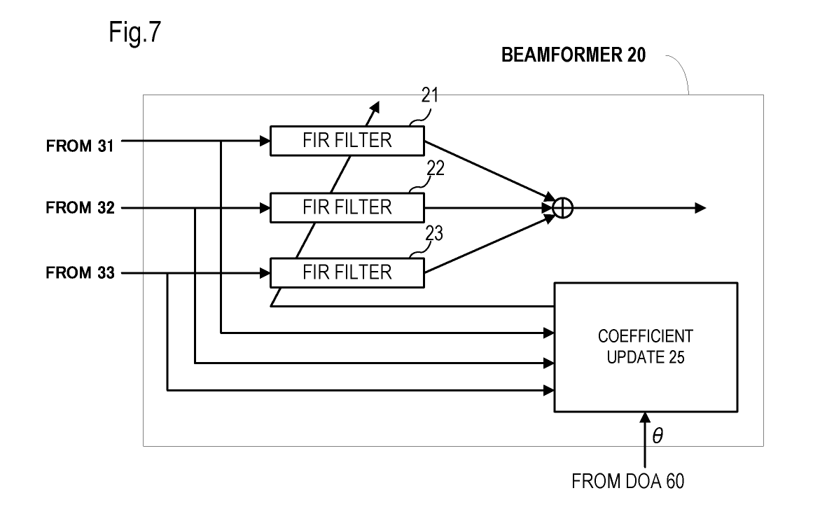

Next, the functions of the BF 20 will be described in detail using FIG. 7, which is a block diagram illustrating the configuration of the BF 20. The BF 20 has a plurality of adaptive filters installed therein, and carries out a beam forming process by filtering input voice signals. For example, the adaptive filters are configured by a FIR filter. Three FIR filters, namely a FIR filter 21, 22, and 23 are illustrated for each microphone in FIG. 7, but more FIR filters may be provided.

When the direction of arrival (θ) of the voice is input from the DOA 60, a beam coefficient renewing unit 25 renews the coefficient of the FIR filters. For example, the beam coefficient renewing unit 25 renews the coefficient of the FIR filters using an appropriate algorithm based on the input voice signal so that an output signal is at its minimum, under constraining conditions that the gain at the focus angle based on the renewed direction of arrival (θ) is 1.0. Therefore, because noise arriving from directions other than the direction of arrival (θ) can be minimized, it is possible to selectively collect voice in the direction of arrival (θ).

The BF 20 repeats processes such as those described above, and outputs a voice signal corresponding to the direction of arrival (θ). By this, the signal processing unit 15 can always collect sound with the direction having a human voice as the direction of arrival (θ) at high sensitivity. In this manner, because a human voice can be tracked, the signal processing unit 15 can suppress the deterioration in sound quality of a human voice due to noise.

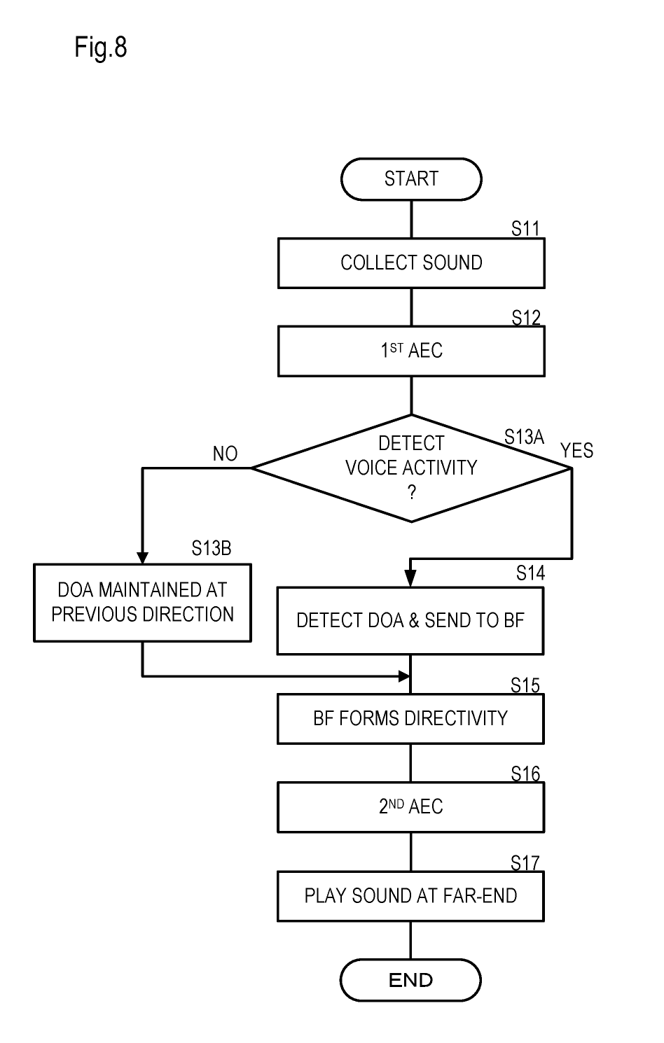

The operation of the sound emitting/collecting device 10 will be described below using FIG. 8, which is a flowchart illustrating the operation of the sound emitting/collecting device 10. First, the sound emitting/collecting device 10 collects sound in the microphone 11, the microphone 12, and the microphone 13 (S11). The voice collected in the microphone 11, the microphone 12, and the microphone 13 is sent to the signal processing unit 15 as a voice signal. Next, the first echo canceller 31, the first echo canceller 32, and the first echo canceller 33 carry out a first echo canceling process (S12). The first echo canceling process is a subtraction process as described above, and is a process in which the echo component is removed from the collected sound signal input to the first echo canceller 31, the first echo canceller 32, and the first echo canceller 33.

Continuing to refer to FIG. 8, after the first echo canceling process, the VAD 50 carries out an analysis of various voice features in the voice signal using the neural network 57 (S13A). When the VAD 50 determines that the collected sound signal is voice information as a result of the analysis (S13A: Yes), the VAD 50 outputs a voice flag to the DOA 60. When the VAD 50 determines that there is no human voice (S13A: No), the VAD 50 does not output a voice flag to the DOA 60, and, the direction of arrival (θ) is maintained at the preceding direction of arrival (θ) (S13A). In the event that the detection of the direction of arrival (θ) in the DOA 60 is omitted when there is no voice flag input, it is possible to omit unnecessary processes, and sensitivity is not given to sound sources other than a human voice. Next, when the voice flag is output to the DOA 60, the DOA 60 detects the direction of arrival (θ) (S14). The detected direction of arrival (θ) is input to the BF 20.

The BF 20 forms directivity (FIG. 8, S15) by adjusting the filter coefficient of the input voice signal based on the direction of arrival (θ). Accordingly, the BF 20 can selectively collect voice in the direction of arrival (θ) by outputting a voice signal corresponding to the direction of arrival (θ). Next, the second echo canceller 40 carries out a second non-linear echo canceling process (S16). The second echo canceller 40 carries out a frequency spectrum amplitude multiplication process on the signal that has undergone the beam forming process in the BF 20. Therefore, the second echo canceller 40 can remove a remaining echo component that could not be removed in the first echo canceling process. The voice signal with the echo component removed is output from the second echo canceller 40 to the signal processing unit 15 via the interface (I/F) 19. The speaker 70L or the speaker 70R emit sound based on the voice signal input from the signal processing unit 15 via the interface (I/F) 19 (S17) being signal processed by the signal processing unit 15.

Note that in the present embodiment, an example of the sound emitting/collecting device 10 was given as a sound emitting/collecting device 10 having the functions of both emitting sound and collecting sound, but the present invention is not limited to this. For example, it may be a sound collecting device having the function of collecting sound.

The forgoing description, for purposes of explanation, used specific nomenclature to provide a thorough understanding of the invention. However, it will be apparent to one skilled in the art that specific details are not required in order to practice the invention. Thus, the forgoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

We claim:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. A sound collecting device, comprising:
a plurality of microphones;
a beam forming unit that forms directivity by processing a sound signal collected by the plurality of microphones; and
a first acoustic echo canceller disposed on the front of the beam forming unit and a second acoustic echo canceller disposed on the back of the beam forming unit.

24. The sound collecting device according to claim 23, wherein the first acoustic echo canceller carries out a subtraction process.

25. The sound collecting device according to claim 23, wherein the second acoustic echo canceller carries out a frequency spectrum amplitude multiplication process.

26. The sound collecting device according to claim 23, wherein the first acoustic echo canceller carries out echo canceling on each sound signal collected by the plurality of microphones.

27. The sound collecting device according to claim 23, wherein a direction of arrival unit that detects a direction of arrival of a sound source is provided on the back of the first echo canceller.

28. The sound collecting device according to claim 27, wherein the direction of arrival detected by the direction of arrival unit is used by the beam forming unit to form directivity.

29. The sound collecting device according to claim 23, wherein a voice activity detection unit that carries out a determination of voice activity is provided on the back of the first echo canceller.

30. The sound collecting device according to claim 29, wherein the direction of arrival unit carries out a process for detecting the direction of arrival when it is determined by the voice activity detection unit that there is voice activity, and the direction of arrival unit maintains the value of the direction of arrival that was previously detected when it is determined in the voice activity detection unit that there is no voice activity.

31. The sound collecting device according to claim 29, wherein the voice activity detection unit carries out a determination of the voice activity using a neural network.

32. The sound collecting device of claim 23, further comprising the first echo canceller performing an echo canceling process based on a signal input to a speaker.

33. A signal processing method, comprising:
performing a first acoustic echo canceling process on at least one of a sound signal collected by a plurality of microphones;
forming directivity using the sound signal that has undergone the first acoustic echo canceling process; and
performing a second acoustic echo canceling process on the sound signal after forming the directivity.

34. The signal processing method according to claim 33, wherein the first acoustic echo canceling process is a process for subtracting an estimated echo component.

35. The signal processing method according to claim 33, wherein the second acoustic echo canceling process is a frequency spectrum amplitude multiplication process.

36. The signal processing method according to claim 33, wherein the first echo canceling process carries out echo canceling on each sound signal collected by the plurality of microphones.

37. The signal processing method according to claim \33, wherein a direction of arrival of a sound source is detected after the first echo canceling process.

38. The signal processing method according to claim 33, wherein a determination is carried out as to whether there is voice activity or not voice activity after the first echo canceling process.

39. An audio signal processing method, comprising:
removing, by a first acoustic echo canceller comprising a local sound collection system, at least a portion of an acoustic echo component from an audio signal collected at any one of a plurality of microphones in a microphone array comprising the sound collection device;
forming a microphone array beam using the audio signals that have undergone the first echo canceling process, the beam being directed to a source of the audio signal received by the microphone array, and
removing, by a second acoustic echo canceller, a remaining acoustic echo component from the audio signal subsequent to the beam forming process, and sending the resulting echo removed audio signal to a remote sound collection system.

40. The audio signal processing method according to claim 39, wherein the first acoustic echo canceller employs linear signal processing to cancel acoustic echo from the audio signal.

41. The audio signal processing method according to claim 39, wherein the second acoustic echo canceller employs non-linear audio signal processing to cancel acoustic echo from the audio signal.

42. The audio signal processing method according to claim 39, wherein a direction of arrival of the audio signal is calculated using two different echo removed audio signals from each of two of the plurality of the first acoustic echo cancellers.

43. The audio signal processing method according to claim 39, wherein voice activity is detected in the audio signal based on an analysis of the echo removed audio signal received from any one of the plurality of the first acoustic echo cancellers.
